(19) United States
(12) Patent Application Publication
(10) Pub. No.: US 2011/0009171 A1
(43) Pub. Date: Jan. 13, 2011

(54) POWER SUPPLY CIRCUIT AND ELECTRONIC DEVICE

(75) Inventors: Masatoshi Watanabe, Kanagawa-ken (JP); Mitsuru Sugawara, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/832,290

(22) Filed: Jul. 8, 2010

(30) Foreign Application Priority Data
Jul. 9, 2009 (JP) 2009-162371

(51) Int. Cl. H02J 7/00; G05F 1/00; H04W 52/00

(52) U.S. Cl. 455/573; 323/273; 320/107

(57) ABSTRACT

According to one embodiment, a power supply circuit includes a power switch section, an error amplifier, a wiring and a reset switch section. The error amplifier has one input portion connected to the output terminal, the other input portion and an output portion. The error amplifier outputs the control potential via the output portion to make the resistance of the power switch section high so that potential applied to the one input portion is high to potential applied to the other input portion. The wiring connects a reference terminal to the other input potion. In addition, the reset switch section is configured to isolate the wiring from a baseline potential when the input terminal is supplied with a potential, and to connect the wiring to the baseline potential when the input terminal is not supplied with the potential.

### CROSS-REFERENCE TO RELATED APPLICATIONS

This application is based upon and claims the benefit of priority from the prior Japanese Patent Application No. 2009-162371, filed on Jul. 9, 2009; the entire contents of which are incorporated herein by reference.

### FIELD

Embodiments described herein relate generally to a power supply circuit and an electronic device having the power supply circuit.

### BACKGROUND

A mobile electronic device, such as a cellular phone, includes a rechargeable battery as a power supply, and is used by repetitively recharging the rechargeable battery. In recharging the rechargeable battery, typically, a dedicated adaptor is used to supply a prescribed recharging voltage to the electronic device.

Users manually connect an electronic device to the adaptor for recharging the electronic device. For instance, the users bring the recharging electrode of the electronic device into contact with the electrode of a recharging dock by mounting the electronic device on the recharging dock. Or users insert a plug of an adaptor into a recharging terminal of the electronic device. However, in these operations, the connection state between the adaptor and the electronic device may become unstable, and the recharging voltage is intermittently inputted to the electronic device. Thereby, a high inrush voltage may be generated in the electronic device. And the inrush voltage may be applied to parts of the electronic device.

### BRIEF DESCRIPTION OF THE DRAWINGS

FIG. 1 is a circuit diagram illustrating a power supply circuit according to a first embodiment;

FIGS. 2A to 2F are timing charts illustrating the variation of potentials;

FIG. 3 is a circuit diagram illustrating a switch circuit in a first example of the first embodiment;

FIG. 4 is a circuit diagram illustrating a switch circuit in a second example of the first embodiment;

FIG. 5 is a circuit diagram illustrating a soft-start circuit and an error amplifier of a power supply circuit according to a second embodiment;

FIG. 6 is a circuit diagram illustrating a power supply circuit according to a third embodiment; and

FIG. 7 is a block diagram illustrating a cellular phone according to a fourth embodiment.

### DETAILED DESCRIPTION

In general, according to one embodiment, a power supply circuit includes a power switch section, an error amplifier, a wiring and a reset switch section. The power switch section is connected between an input terminal and an output terminal and is configured to vary resistance in response to an inputted control potential. The error amplifier has one input portion connected to the output terminal, the other input portion and an output portion. The error amplifier outputs the control potential via the output portion to make the resistance of the power switch section high so that potential applied to the one input portion is high to potential applied to the other input portion. The wiring connects a reference terminal to the other input potion. In addition, the reset switch section is configured to isolate the wiring from a baseline potential when the input terminal is supplied with a potential, and to connect the wiring to the baseline potential when the input terminal is not supplied with the potential.

According to another embodiment, an electronic device includes the above power supply circuit and a rechargeable battery connected to an output terminal of the power supply circuit.

Embodiments will now be described with reference to the drawings.

At the outset, a first embodiment is described.

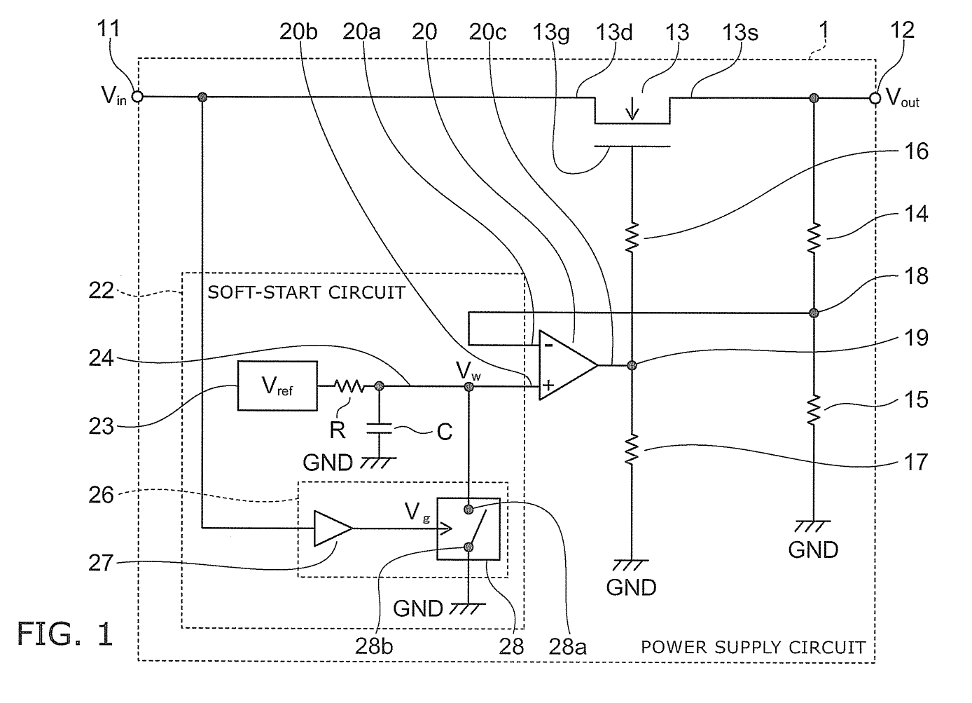

FIG. 1 is a circuit diagram illustrating a power supply circuit according to this embodiment.

As shown in FIG. 1, the power supply circuit 1 according to this embodiment is a power supply circuit for outputting a constant output potential Vₒᵤₜ in response to input of an unknown or indefinite input potential Vᵢₙ. For instance, the power supply circuit 1 is a power supply circuit mounted in a cellular phone. For example, a set potential Vₛₑₜ of the output potential Vₒᵤₜ is illustratively 5 V. A supply potential V_{spply} externally supplied as the input potential Vᵢₙ may be higher than the set potential Vₛₑₜ, and is illustratively 10 V.

As shown in FIG. 1, the power supply circuit 1 includes an input terminal 11 for being inputted potential Vᵢₙ, and an output terminal 12 for outputting the output potential Vₒᵤₜ. An n-channel field effect transistor (nMOS) 13 as a power switch section is connected between the input terminal 11 and the output terminal 12. Namely a drain electrode 13d of the nMOS 13 is connected to the input terminal 11, and a source electrode 13s of the nMOS 13 is connected to the output terminal 12. The power switch section constituted by the nMOS 13 varies its resistance in response to a control potential inputted to a gate electrode 13g. The term “connected” used herein means not only fixed and short-circuit connection by a wiring and the like, but also connection via a switch element, resistance element and the like.

Two resistances 14 and 15 are connected in series in this order between the output terminal 12 and a baseline potential, such as ground potential GND. Two resistances 16 and 17 are connected in series in this order between the gate electrode 13g of the nMOS 13 and the baseline potential, such as ground potential GND. Although the baseline potential is illustratively the ground potential GND in this embodiment, the baseline potential is not limited to the ground potential.

Furthermore, the power supply circuit 1 includes an error amplifier 20. The error amplifier 20 includes a negative side input portion 20a, a positive side input portion 20b, and an output portion 20c. The error amplifier 20 compares the potential inputted to the negative side input portion 20a and the potential inputted to the positive side input portion 20b. The error amplifier 20 amplifies the difference between the potentials and outputs the amplified difference from the output portion 20c. The error amplifier 20 makes the potential outputted from the output portion 20c high, so that the potential inputted to the positive side input portion 20b relative to the potential inputted to the negative side input portion 20a is high. The negative side input portion 20a of the error amplifier 20 is connected to a connection node 18 between the resistance 14 and the resistance 15. The output portion 20c is connected to a connection node 19 between the resistance 16 and the resistance 17. That is, the negative side input portion 20a is connected to the output terminal 12 via the resistance 14, and the output portion 20c is connected to the gate electrode 13g of the nMOS 13 via the resistance 16.

Moreover, the power supply circuit 1 includes a soft-start circuit 22. As described later, the soft-start circuit 22 controls a startup of the nMOS 13, and also resets the startup of the nMOS 13 when the supply potential V_{spply} ceases to be supplied to the input terminal 11. The soft-start circuit 22 includes a reference terminal 23 inputted a reference potential V_{ref}. The reference potential V_{ref} is a constant potential generated by supplying of the supply potential V_{spply} to the power supply circuit 1. The reference potential V_{ref} is lower than the supply potential V_{spply} and the set potential Vₛₑₜ. For example, the reference potential V_{ref} is 0.9 V.

The soft-start circuit 22 includes a wiring 24. The reference terminal 23 is connected to the positive side input portion 20b of the error amplifier 20 by the wiring 24. The wiring 24 is given a resistance R. The resistance R includes an intentionally provided resistance and an inevitable wiring resistance. Furthermore, a capacitance C is given between the wiring 24 and the ground potential GND. The capacitance C includes an intentionally provided capacitance and an inevitable parasitic capacitance. The potential of the wiring 24 is referred to as wiring potential V_{W}.

The soft-start circuit 22 includes a reset switch section 26. The reset switch section 26 includes a buffer 27 and a switch circuit 28. An input end of the buffer 27 is connected to the input terminal 11, and an output end of the buffer 27 is connected to the switch circuit 28. The buffer 27 is supplied with the power supply potential and the ground potential. The buffer 27 outputs a signal of high level H (power supply potential) as an external input signal V_{g} from the output end when the potential applied to the input end is higher than a prescribed value. And the buffer 27 outputs a signal of low level L (ground potential) as the external input signal V_{g} from the output end when the potential applied to the input end is lower than the prescribed value. Thus, the buffer 27 outputs high level when the input terminal 11 is supplied with the supply potential V_{spply} as the input potential V. And the buffer 27 outputs low level when the input terminal 11 is not supplied with the supply potential V_{spply}.

One terminal 28a of the switch circuit 28 is connected to the wiring 24, and the other terminal 28b is connected to the ground potential GND. The switch circuit 28 turns the path between the terminal 28a and the terminal 28b into the non-conducting state (off-state) when the external input signal V_{g} of high level is inputted from the buffer 27. And the switch circuit 28 turns the path between the terminal 28a and the terminal 28b into the conducting state (on-state) when the external input signal V_{g} of low level is inputted.

Next, an operation of the power supply circuit according to this embodiment is described.

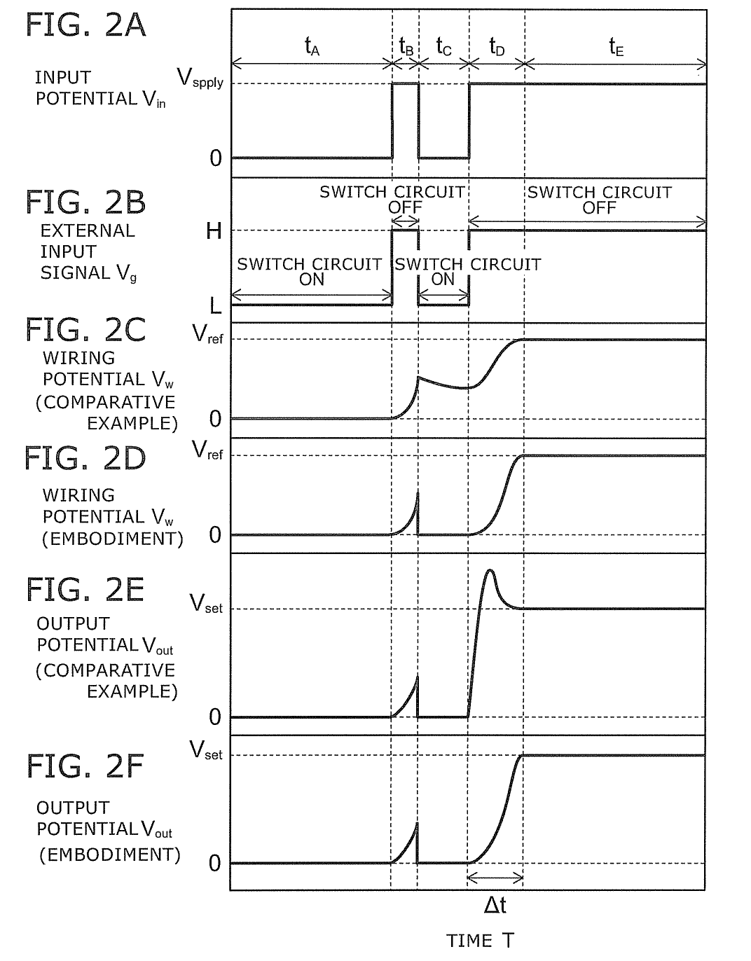

FIGS. 2A to 2F are timing charts illustrating the variation of potentials, where the horizontal axis represents time, and the vertical axis represents the potential of each portion of the power supply circuit.

In addition to potentials in the power supply circuit according to this embodiment, FIGS. 2A to 2F also show potentials in a power supply circuit according to a comparative example. The power supply circuit according to the comparative example is a circuit obtained by eliminating the reset switch section 26 from the power supply circuit 1 shown in FIG. 1. In FIGS. 2A to 2F, FIG. 2A shows the input potential Vᵢₙ, FIG. 2B shows the external input signal V_{g}, FIG. 2C shows the wiring potential V_{W} of the comparative example, FIG. 2D shows the wiring potential V_{W} of this embodiment, FIG. 2E shows the output potential Vₒᵤₜ of the comparative example, and FIG. 2F shows the output potential Vₒᵤₜ of this embodiment. In the following, the operation of the power supply circuit 1 is described with reference to FIGS. 1 and 2A to 2F.

First, one state of the power supply circuit 1 is described. The input terminal 11 of the power supply circuit 1 is not supplied with the supply potential V_{spply}, i.e., the input potential Vᵢₙ of the input terminal 11 is 0 V or the input terminal 11 is floating at this state.

As shown in the period t_{A} of FIGS. 2A to 2F, in this case, the potential at the input end of the buffer 27 is also set to 0 V or placed in the floating state. Hence, a signal of low level L is outputted as the external input signal V_{g} from the output end of the buffer 27. Thus, the switch circuit 28 is turned into the conducting state (ON), and the terminal 28a is connected to the terminal 28b. However, in the state in which the power supply circuit 1 is not supplied with the supply potential V_{spply}, the reference terminal 23 is also not supplied with the reference potential V_{ref}. Hence, no current flows in the wiring 24 and the switch circuit 28, and the wiring potential V_{W} of the wiring 24 is the ground potential (0 V).

On the other hand, because the gate electrode 13g of the nMOS 13 is applied with the ground potential (GND), the nMOS 13 is in the non-conducting state. Furthermore, because the output terminal 12 is connected to the ground potential via the resistance 14 and the resistance 15, the potential of the output terminal 12 and the connection node 18 is also the ground potential. Hence, the negative side input portion 20a of the error amplifier 20 connected to the connection node 18 is applied with the ground potential. The positive side input portion 20b of the error amplifier 20 connected to the wiring 24 is also applied with the ground potential. Thus, the output portion 20c of the error amplifier 20 does not output potential.

Next, the case where the input terminal 11 of the power supply circuit 1 is intermittently supplied with the supply potential V_{spply} is described. For instance, it is assumed that users of the cellular phone including the power supply circuit 1 insert the plug of the adaptor into the recharging terminal of the cellular phone to recharge the cellular phone. In this case, the connection state between the plug and the recharging terminal becomes unstable when the users insert the plug into the recharging terminal. Hence the supply potential V_{spply} is intermittently inputted to the input terminal 11 of the power supply circuit 1.

As shown in the period t_{B} of FIGS. 2A to 2F, when the plug of the adaptor is brought into contact with the recharging terminal of the cellular phone, the input terminal 11 is supplied with the supply potential V_{spply} as the input potential Vᵢₙ. Thus, the input end of the buffer 27 is also supplied with the supply potential V_{spply}, and a signal of high level H is outputted as the external input signal V_{g} from the output end of the buffer 27. Accordingly, the switch circuit 28 is turned into the non-conducting state (OFF), and the terminal 28a is isolated from the terminal 28b.

Furthermore, the reference terminal 23 is supplied with the reference potential V_{ref}. At this time, the wiring 24 includes the resistance R and the capacitance C. So, the wiring potential V_{W} of the wiring 24 gradually increases from the ground potential toward the reference potential V_{ref} in accordance with the time constant Δt determined by the resistance R and the capacitance C. When the wiring potential V_{W} inputted to the positive side input portion 20b gradually increases relative to the potential of the connection node 18 inputted to the negative side input portion 20a, the potential outputted from the output portion 20c gradually increases. Thus, the control potential inputted to the gate electrode 13g of the nMOS 13 increases. Hence, a state of the nMOS 13 gradually transitions to the conducting state, and the source-drain resistance of the nMOS 13 gradually decreases. Consequently, the output potential Vₒᵤₜ of the output terminal 12 also gradually increases. In response thereto, the potential of the connection node 18 also increases. And the potential of the connection node 18 is fed back to the negative side input portion 20a of the error amplifier 20.

That is, the wiring potential V_{W} inputted to the positive side input portion 20b of the error amplifier 20 gradually increases. And also, the potential inputted to the negative side input portion 20a in accordance with the output potential Vₒᵤₜ gradually increases. At this time, if the increase of the output potential Vₒᵤₜ lags behind the increase of the wiring potential V_{W}, the potential of the negative side input portion 20a becomes lower than the potential of the positive side input portion 20b of the error amplifier 20. Thus the potential outputted from the output portion 20c increases. The resistance of the nMOS 13 decreases. And the increase of the output potential Vₒᵤₜ of the output terminal 12 is accelerated.

On the other hand, if the increase of the output potential Vₒᵤₜ precedes the increase of the wiring potential V_{W}, the potential of the negative side input portion 20a becomes higher than the potential of the positive side input portion 20b of the error amplifier 20. Thus the potential outputted from the output portion 20c decreases. The resistance of the nMOS 13 increases. And the increase of the output potential Vₒᵤₜ of the output terminal 12 is suppressed. Thus, the error amplifier 20 outputs the control potential via the output portion 20c. The error amplifier 20 makes the source-drain resistance of the nMOS 13 high by the control potential so that the potential applied to the negative side input portion 20a is high relative to the potential applied to the positive side input portion 20b. Consequently, negative feedback with reference to the wiring potential V_{W} is applied to the output potential Vₒᵤₜ. And the output potential Vₒᵤₜ gradually increases in accordance with the time constant Δt. Thus, in the period t_{B}, no inrush voltage occurs in the power supply circuit 1.

Subsequently, as shown in the period t_{C} of FIGS. 2A to 2F, the plug of the adaptor loses contact with the recharging terminal of the cellular phone, and the supply of the supply potential V_{spply} to the input terminal 11 is suspended. Then, the output potential Vₒᵤₜ turns to the ground potential (0 V), and the potential inputted to the negative side input portion 20a of the error amplifier 20 also turns to the ground potential. Furthermore, the supply of the reference potential V_{ref} is also stopped. Moreover, the capacitance C accumulates a certain amount of charge immediately before suspension of the supply of the supply potential V_{spply}. So far the operation of this embodiment including the reset switch section 26 is same the operation of the comparative example lacking the reset switch section 26.

However, in the comparative example, even if the supply of the reference potential V_{ref} is stopped, the wiring potential V_{W} of the wiring 24 does not immediately turn to the ground potential because of the charge accumulated in the capacitance C. The wiring potential V_{W} gradually decreases by spontaneous discharge of the capacitance C. Then, as shown in the period t_{D} of FIGS. 2A to 2F, before the wiring potential V_{W} turns to the ground potential, the supply potential V_{spply} is supplied again to the input terminal 11. Then, the wiring potential V_{W} starts to increase from a higher potential than the ground potential. On the other hand, the potential of the connection node 18 is the ground potential. Hence, the potential of the positive side input portion 20b becomes significantly higher than the potential of the negative side input portion 20a of the error amplifier 20. Thus the potential outputted from the output portion 20c also becomes higher. And a state of the nMOS 13 sharply transitions to the conducting state. Thus, an excessive current flows in the nMOS 13, an inrush voltage generates at the output terminal 12, and the output potential Vₒᵤₜ temporarily exceeds the set potential Vₛₑₜ. Consequently the rechargeable battery (not shown) connected to the output terminal 12 is damaged.

In contrast, in this embodiment, a reset switch section 26 is provided. Hence, as shown in the period t_{C} of FIGS. 2A to 2F, when the plug of the adaptor loses contact with the recharging terminal of the cellular phone, and the supply of the supply potential V_{spply} to the input terminal 11 is suspended, then the external input signal V_{g} of low level L is outputted from the output end of the buffer 27, and the switch circuit 28 is turned into the conducting state. Thus, the wiring 24 is connected to the ground potential GND via the switch circuit 28. The charge accumulated in the capacitance C is rapidly discharged to the ground potential GND via the wiring 24 and the switch circuit 28. And the wiring potential V_{W} quickly turns to the ground potential. Consequently, as shown in the period t_{D} of FIGS. 2A to 2F, even if the supply potential V_{spply} is supplied again to the input terminal 11, the wiring potential V_{W} starts to increase from the ground potential as in the period t_{B}, and hence no inrush voltage occurs. Subsequently, as shown in the period t_{E}, the supply potential V_{spply} is continuously supplied to the input terminal 11. Thus, the power supply circuit 1 is placed in the steady state when the output potential Vₒᵤₜ reaches the set potential Vₛₑₜ. And the output potential Vₒᵤₜ is fixed to the set potential Vₛₑₜ.

Next, an effect of this embodiment is described.

According to this embodiment, the power supply circuit 1 has the soft-start circuit 22 and the error amplifier 20. Thus the power supply circuit 1 can adjust the output potential Vₒᵤₜ to the set potential Vₛₑₜ, even if the supply potential V_{spply} is unknown. Furthermore, the soft-start circuit 22 and the error amplifier 20 can control the startup of the nMOS 13 for soft-start in accordance with the time constant Δt determined by the resistance R and the capacitance C.

Furthermore, as described above, the comparative example lacks the reset switch section 26. Therefore, in the case where the supply potential V_{spply} is intermittently supplied to the input terminal 11, if the supply potential V_{spply} is newly applied before completion of spontaneous discharge of the capacitance C, an inrush voltage occurs. In contrast, in this embodiment, the reset switch section 26 is turned into the conducting state when the supply of the supply potential V_{spply} is stopped. And the charge accumulated in the capacitance C is forcibly discharged. Hence the wiring potential V_{W} is reset each time. Thus, even if the supply potential V_{spply} is supplied again, no inrush voltage occurs. Consequently, even in such a situation in which the connection state between the plug of the adaptor and the recharging terminal of the cellular phone becomes unstable, no damage is caused to the inside of the cellular phone. Furthermore, according to this embodiment, the adjustment of the output potential Vₒᵤₜ and the resetting of the wiring potential V_{W} described above can be automatically performed without requiring the user's operation.

Next, examples of this embodiment are described.

At the outset, a first example is described.

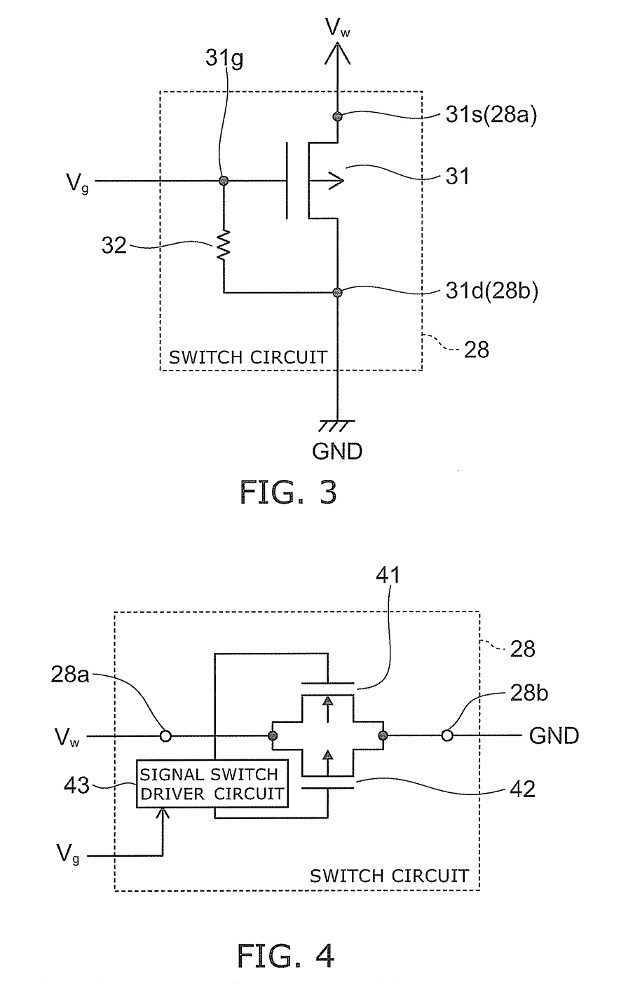

FIG. 3 is a circuit diagram illustrating a switch circuit in this example.

As shown in FIG. 3, in this example, the switch circuit 28 is made of a pull-down p-channel field effect transistor (pMOS) 31. The pMOS 31 includes a source electrode 31s, a drain electrode 31d and a gate electrode 31g. The source electrode 31s constitutes a terminal 28a and is connected to the wiring 24 (see FIG. 1). The drain electrode 31d constitutes a terminal 28b and is connected to the ground potential GND. And the gate electrode 31g is connected to the output end of the buffer 27 (see FIG. 1). Furthermore, the gate electrode 31g of the pMOS 31 is connected to the drain electrode 31d via a resistance 32.

In this example, the external input signal V_{g} outputted from the output end of the buffer 27 is applied to the gate electrode 31g of the pMOS 31. Hence, when the external input signal V_{g} is high level, the pMOS 31 is turned into the non-conducting state. On the other hand, when the external input signal V_{g} is low level, the pMOS 31 is turned into the conducting state. Furthermore, when no potential is externally supplied to the power supply circuit, the gate electrode 31g of the pMOS 31 is applied with the ground potential via the resistance 32. Hence the pMOS 31 is turned into the conducting state. Thus, the switch circuit 28 can be realized.

Next, a second example is described.

FIG. 4 is a circuit diagram illustrating a switch circuit in this example.

As shown in FIG. 4, in this example, the switch circuit 28 includes an nMOS 41, a pMOS 42, and a signal switch driver circuit 43. More specifically, the drain electrode of the nMOS 41 and the source electrode of the pMOS 42 are commonly connected to the terminal 28a. And the source electrode of the nMOS 41 and the drain electrode of the pMOS 42 are commonly connected to the terminal 28b. Furthermore, the signal switch driver circuit 43 is configured to receive the external input signal V_{g}, and to independently output an output signal to each of the gate electrode of the nMOS 41 and the gate electrode of the pMOS 42. The signal switch driver circuit 43 is a logic circuit. The signal switch driver circuit 43 applies a negative potential to the gate electrode of the nMOS 41 and a positive potential to the gate electrode of the pMOS 42 in response to input of the external input signal V_{g} of high level. And the signal switch driver circuit 43 applies a positive potential to the gate electrode of the nMOS 41 and a negative potential to the gate electrode of the pMOS 42 in response to input of the external input signal V_{g} of low level.

In this example, when the external input signal V_{g} of high level is outputted from the output end of the buffer 27, the signal switch driver circuit 43 applies a negative potential to the gate electrode of the nMOS 41 and a positive potential to the gate electrode of the pMOS 42 to turn both the nMOS 41 and the pMOS 42 into the non-conducting state. Thus, the terminal 28a is electrically cut off from the terminal 28b. On the other hand, when the external input signal V_{g} of low level is outputted, the signal switch driver circuit 43 applies a positive potential to the gate electrode of the nMOS 41 and a negative potential to the gate electrode of the pMOS 42 to turn both the nMOS 41 and the pMOS 42 into the conducting state. Thus, the terminal 28a is connected to the terminal 28b. Therefore, the switch circuit 28 can be realized.

Next, a second embodiment is described.

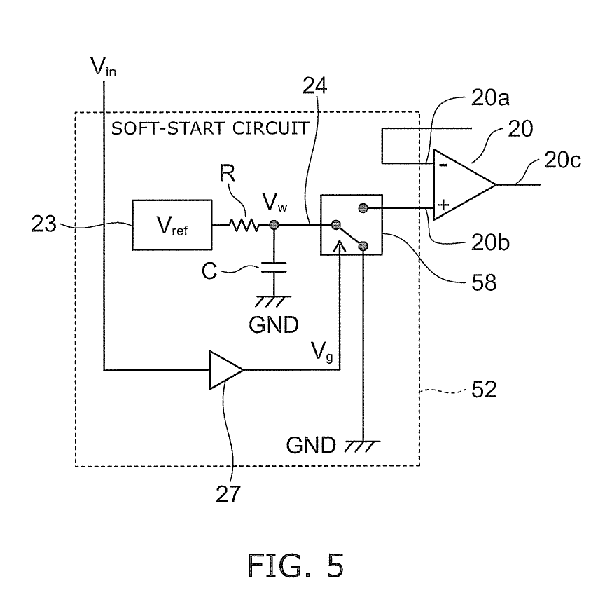

FIG. 5 is a circuit diagram illustrating a soft-start circuit and an error amplifier of a power supply circuit according to this embodiment.

As shown in FIG. 5, the power supply circuit according to this embodiment is different from the power supply circuit 1 (see FIG. 1) according to the above first embodiment in that the soft-start circuit 22 is replaced by a soft-start circuit 52.

The soft-start circuit 52 includes a switch circuit 58 instead of the switch circuit 28 (see FIG. 1). The switch circuit 58 is an analog switch interposed between the wiring 24 and the positive side input portion 20b of the error amplifier 20. The switch circuit 58 is configured to switch whether to connect the wiring 24 to the positive side input portion 20b or to the ground potential GND. The switch circuit 58 connects the wiring 24 to the positive side input portion 20b in response to the external input signal V_{g} of high level inputted from the buffer 27. And the switch circuit 58 connects the wiring 24 to the ground potential GND in response to the external input signal V_{g} of low level inputted from the buffer 27. The configuration of this embodiment other than the foregoing is similar to that of the above first embodiment.

Next, an operation and effect of this embodiment are described.

Also in this embodiment, when the supply potential V_{spply} ceases to be supplied to the input terminal 11 (see FIG. 1), the external input signal V_{g} of low level is outputted from the output end of the buffer 27. Therefore, the switch circuit 58 cuts off the wiring 24 from the positive side input portion 20b and connects to the ground potential GND. Consequently, the charge accumulated in the capacitance C is quickly discharged to the ground potential, and the wiring potential V_{W} of the wiring 24 is quickly returned to the ground potential. Thus, the wiring potential V_{W} is reset every time when the supply of the supply potential V_{spply} is interrupted. Therefore, an effect similar to that of the above first embodiment is achieved. The operation and effect of this embodiment other than the foregoing are similar to those of the above first embodiment.

Next, a third embodiment is described.

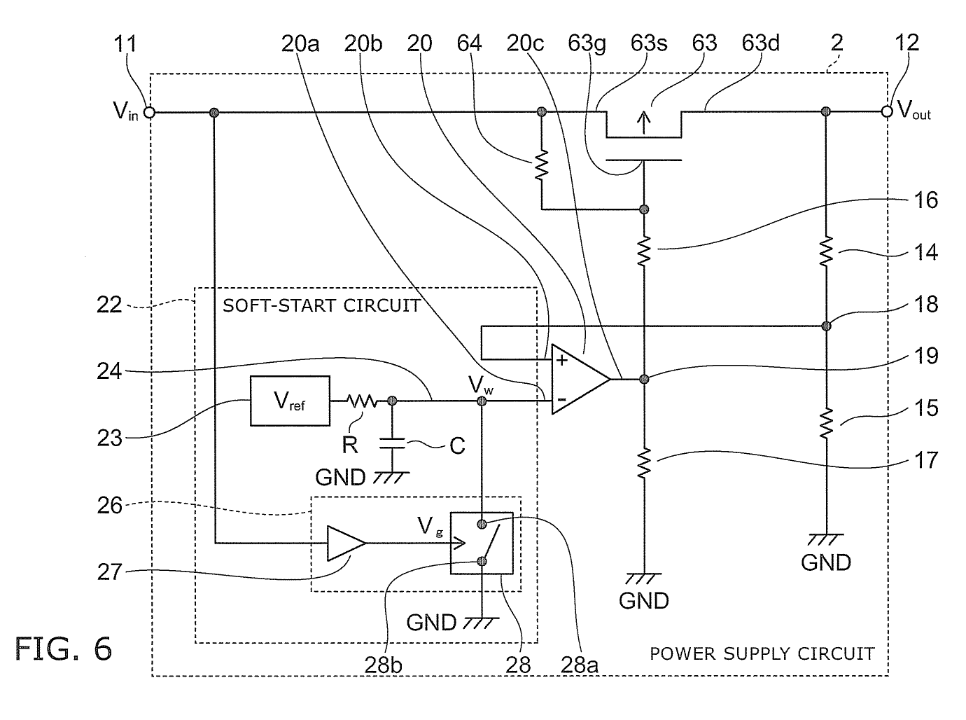

FIG. 6 is a circuit diagram illustrating a power supply circuit according to this embodiment.

As shown in FIG. 6, the power supply circuit 2 according to this embodiment is different from the power supply circuit 1 (see FIG. 1) according to the above first embodiment in that the nMOS 13 is replaced by a pMOS 63. A resistance 64 is connected between the source electrode 63s and the gate electrode 63g of the pMOS 63. The connection at the negative side input portion 20a and the positive side input portion 20b of the error amplifier 20 is reversed relative to the above first embodiment. More specifically, the source electrode 63s of the pMOS 63 is connected to the input terminal 11, and a drain electrode 63d of the pMOS 63 is connected to the output terminal 12. And a negative side input portion 20a of the error amplifier 20 is connected to the wiring 24, and a positive side input portion 20b of the error amplifier 20 is connected to the connection node 18. The configuration of this embodiment other than the foregoing is similar to that of the above first embodiment.

Next, an operation and effect of this embodiment are described.

In this embodiment, when the supply potential V_{spply} is supplied to the input terminal 11 as the input potential Vᵢₙ, the supply potential V_{spply} is also supplied to the gate electrode 63g of the pMOS 63 via the resistance 64. Hence the pMOS 63 is initially turned into the non-conducting state. On the other hand, the reference terminal 23 is supplied with the reference potential V_{ref}. Hence, the wiring potential V_{W} of the wiring 24 gradually increases in accordance with the time constant Δt determined by the resistance R and the capacitance C.

At this time, if the increase of the output potential Vₒᵤₜ lags behind the increase of the wiring potential V_{W}, the potential inputted to the positive side input portion 20b becomes lower than the potential inputted to the negative side input portion 20b of the error amplifier 20. Then the potential outputted from the output portion 20c decreases, and the resistance of the pMOS 63 decreases. Thus, the output potential Vₒᵤₜ starts to increase. On the other hand, if the increase of the output potential Vₒᵤₜ precedes the increase of the wiring potential V_{W}, the potential inputted to the positive side input portion 20b becomes higher than the potential inputted to the negative side input portion 20a of the error amplifier 20. Then the potential outputted from the output portion 20c increases, and the resistance of the pMOS 63 increases. Thus, the increase of the output potential Vₒᵤₜ is suppressed. Therefore, the output potential Vₒᵤₜ is gradually increased while controlling the increasing rate of the output potential V.

Also in this embodiment, as in the above first embodiment, the soft-start circuit 22 includes a reset switch section 26. Thus, the charge accumulated in the capacitance C can be forcibly discharged when the supply of the supply potential V_{spply} is stopped. Therefore, the occurrence of inrush voltage can be prevented. The operation and effect of this embodiment other than the foregoing are similar to those of the above first embodiment.

Next, a fourth embodiment is described.

This embodiment relates to an electronic device, and more particularly to a cellular phone.

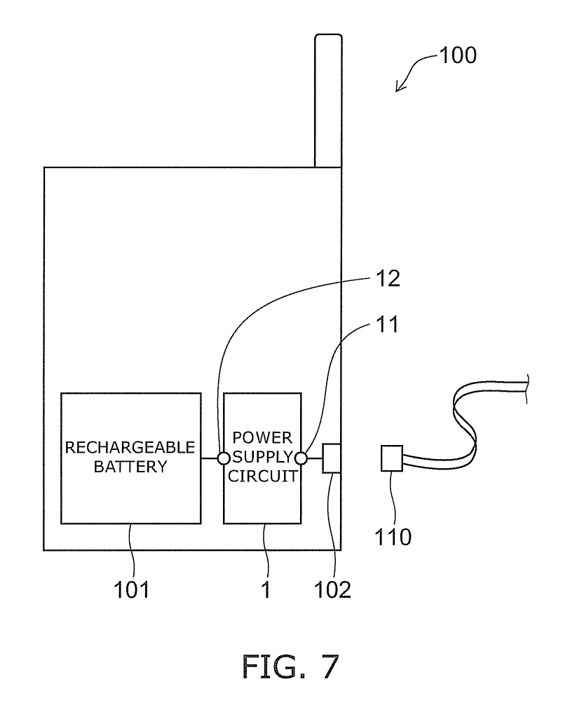

FIG. 7 is a block diagram illustrating a cellular phone according to this embodiment.

As shown in FIG. 7, the cellular phone 100 according to this embodiment includes a power supply circuit 1 and a rechargeable battery 101. The configuration of the power supply circuit 1 is similar to that of the power supply circuit 1 according to the above first embodiment. The input terminal 11 of the power supply circuit 1 is connected to the recharging terminal 102 provided on the casing of the cellular phone 100. And the output terminal 12 of the power supply circuit 1 is connected to the rechargeable battery 101. The rechargeable battery 101 is the power supply of the cellular phone 100. On the other hand, a plug 110 of an external power supply is supplied with the supply potential V_{spply}.

In this embodiment, the plug 110 of the external power supply is inserted into the recharging terminal 102. Thus, the plug 110 is connected to the recharging terminal 102 by being in contact therewith. And the rechargeable battery 101 is recharged. According to this embodiment, the power supply circuit 1 is provided in the cellular phone 100. Thus, even if the supply potential V_{spply} externally supplied is higher than the prescribed set potential Vₛₑₜ, it is automatically converted to the set potential Vₛₑₜ for supply to the rechargeable battery 101. Thus the rechargeable battery 101 can be recharged. Furthermore, even if the connection state between the plug 110 and the recharging terminal 102 becomes unstable, the rechargeable battery 101 can be protected from inrush voltage by the operation described in the first embodiment. It is noted that, the cellular phone 100 may have the power supply circuit according to the above second or third embodiment.

The invention has been described with reference to the embodiments, but the invention is not limited to these embodiments. The above embodiments can be practiced in combination with each other. Furthermore, those skilled in the art can suitably modify the above embodiments by addition, deletion, or design change of components, and such modifications are also encompassed within the scope of the invention as long as they fall within the spirit of the invention. For instance, while the electronic device is illustratively a cellular phone in the above fourth embodiment, the invention is not limited thereto, but is applicable to any electronic device externally supplied with a power supply voltage. In particular, the invention is suitably applicable to electronic devices with a rechargeable battery installed thereon, including portable electronic devices such as digital still cameras, digital video cameras, notebook personal computers, and audio devices.

The above embodiments can realize a power supply circuit capable of stably outputting a prescribed voltage even in the case where the contact state with the external power supply is unstable, and an electronic device provided therewith.

1. A power supply circuit comprising:
a power switch section connected between an input terminal and an output terminal and configured to vary resistance in response to an inputted control potential;
an error amplifier having one input portion connected to the output terminal, the other input portion and an output portion, the error amplifier outputting the control potential via the output portion to make the resistance of the power switch section high so that potential applied to the one input portion is high to potential applied to the other input portion;
a wiring connecting a reference terminal to the other input potion; and
a reset switch section configured to isolate the wiring from a baseline potential when the input terminal is supplied with a potential, and to connect the wiring to the baseline potential when the input terminal is not supplied with the potential.

2. The circuit according to claim 1, wherein the reset switch section includes:
a buffer having an output end and an input end connected to the input terminal, the buffer being configured to output a first potential via the output end when potential applied to the input end is higher than a prescribed value, and to output a second potential via the output end when potential applied to the input end is lower than the prescribed value; and
a switch circuit having one terminal connected to the wiring and another terminal connected to the baseline potential, the switch circuit being configured to turn a path between the one terminal and the another terminal into a non-conducting state when the first potential is inputted from the output end of the buffer, and to turn the path between the one terminal and the another terminal into a conducting state when the second potential is inputted from the output end of the buffer.

3. The circuit according to claim 2, wherein
the switch circuit is a p-channel field effect transistor,
the one terminal is a source electrode of the p-channel field effect transistor,
the another terminal is a drain electrode of the p-channel field effect transistor,
the output end of the buffer is connected to a gate electrode of the p-channel field effect transistor, and
the gate electrode is connected to the drain electrode via a resistance.

4. The circuit according to claim 2, wherein the switch circuit includes:
an n-channel field effect transistor having a drain electrode connected to the one terminal and a source electrode connected to the another terminal;
a p-channel field effect transistor having a source electrode connected to the one terminal and a drain electrode connected to the another terminal; and
a signal switch driver circuit configured to apply a negative potential to the gate electrode of the n-channel field effect transistor and a positive potential to the gate electrode of the p-channel field effect transistor when the first potential is applied from the output end of the buffer, and to apply a positive potential to the gate electrode of the n-channel field effect transistor and a negative potential to the gate electrode of the p-channel field effect transistor when the second potential is applied from the output end of the buffer.

5. The circuit according to claim 2, wherein the first potential is higher than the second potential.

6. The circuit according to claim 1, wherein the reset switch section includes:
a buffer having an output end and an input end connected to the input terminal, the buffer being configured to output a first potential from the output end when potential applied to the input end is higher than a prescribed value, and to output a second potential from the output end when potential applied to the input end is lower than the prescribed value; and
a switch circuit configured to connect the wiring to the another input section when the first potential is inputted from the output end of the buffer, and to connect the wiring to the baseline potential when the second potential is inputted from the output end of the buffer.

7. The circuit according to claim 6, wherein the first potential is higher than the second potential.

8. The circuit according to claim 1, wherein
the power switch section includes an n-channel field effect transistor connected between the input terminal and the output terminal,
the output portion of the error amplifier is connected to a gate electrode of the n-channel field effect transistor, and
the error amplifier makes potential outputted via the output portion low, so that potential inputted to the one input portion is high to potential inputted to the other input portion.

9. The circuit according to claim 1, wherein
the power switch section includes a p-channel field effect transistor connected between the input terminal and the output terminal,
the output portion of the error amplifier is connected to a gate electrode of the p-channel field effect transistor, and
the error amplifier makes potential outputted via the output portion high, so that potential inputted to the one input portion is high to potential inputted to the other input portion.

10. A power supply circuit configured to generate, from an input potential, an output potential lower than the input potential on the basis of a reference potential, the power supply circuit comprising:
a wiring to which the reference potential is applied, the wiring being connected to a baseline potential when the input potential is lower than a prescribed value.

11. An electronic device comprising:
a power supply circuit;
a rechargeable battery connected to an output terminal of the power supply circuit; and
a recharging terminal connected to an input terminal of the power supply circuit and configured to be connected to a plug of an external power supply by being in contact with the plug,
the power supply circuit configured to generate, from an input potential, an output potential lower than the input potential on the basis of a reference potential, the power supply circuit including:
a wiring to which the reference potential is applied, the wiring being connected to a baseline potential when the input potential is lower than a prescribed value.

12. An electronic device comprising:
a power supply circuit; and
a rechargeable battery connected to an output terminal of the power supply circuit
the power supply circuit including:
a power switch section connected between an input terminal and an output terminal and configured to vary resistance in response to an inputted control potential;
an error amplifier having one input portion connected to the output terminal, the other input portion and an output portion, the error amplifier outputting the control potential via the output portion to make the resistance of the power switch section high so that potential applied to the one input portion is high to potential applied to the other input portion;
a wiring connecting the other input potion to a reference terminal; and
a reset switch section configured to isolate the wiring from a baseline potential when the input terminal is supplied with a potential, and to connect the wiring to the baseline potential when the input terminal is not supplied with the potential.

13. The device according to claim 12, further comprising:
a recharging terminal connected to the input terminal and configured to be connected to a plug of an external power supply by being in contact with the plug.

14. The device according to claim 13, wherein the plug is inserted into the recharging terminal.

15. The device according to claim 12, wherein the device is a cellular phone.
